(19) United States
(12) Patent Application Publication
(10) Pub. No.: US 2008/0122862 A1
(43) Pub. Date: May 29, 2008

(54) METHOD AND APPARATUS FOR TRANSMITTING AND RECEIVING MOVING PICTURES BASED ON RGB CODEC

(75) Inventor: Byung-cheol SONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/858,475

(22) Filed: Sep. 20, 2007

(30) Foreign Application Priority Data
Nov. 24, 2006 (KR) 10-2006-0117097

(51) Int. Cl. G09G 5/04

(52) U.S. Cl. 345/604

(57) ABSTRACT

A method and apparatus for transmitting and receiving RGB codec-based moving pictures are provided. The RGB codec-based moving picture transmitting method includes performing RGB-encoding on an RGB image and generating an encoded RGB image; receiving an audio bit stream; and generating a transmission stream on the basis of the encoded RGB image and the audio bit stream, wherein the RGB-encoding is performed using intra prediction or inter prediction for encoding a current image on the basis of a previous RGB image. By receiving and transmitting RGB images without any color format conversion, picture quality deterioration is prevented.

### CROSS-REFERENCE TO RELATED PATENT APPLICATION

This application claims priority from Korean Patent Application No. 10-2006-0117097, filed on Nov. 24, 2006, in the Korean Intellectual Property Office, the disclosure of which is incorporated herein in its entirety by reference.

### BACKGROUND OF THE INVENTION

1. Field of the Invention

Methods and apparatus consistent with the present invention relate to transmitting and receiving moving pictures based on a Red, Green, Blue (RGB) codec, and more particularly, to a method of transmitting and receiving moving pictures without any conversion between RGB images and YCbCr images when the moving pictures are transmitted and received.

2. Description of the Related Art

Moving-picture codecs which are adopted in the majority of existing digital audio/video (AV) systems are based on YCbCr images. Accordingly, even though image information captured by a camera is based on RGB images, considering that compressibility is improved when image information is compressed to YCbCr images, RGB images are converted into YCbCr images and the YCbCr images are compressed. Accordingly, when decoding is performed, these YCbCr images must be converted back into RGB images.

FIG. 1 is a block diagram of a related art YCbCr-based moving-picture codec system.

Referring to FIG. 1, the related art YCbCr-based moving-picture codec system includes an encoding apparatus 120 and a decoding apparatus 140. The encoding apparatus 120 includes a first format conversion unit 122, a sub sampler 124, and a YCbCr encoder 126.

The first format conversion unit 122 converts a received RGB image into a YCbCr image. If a codec of a 4:2:0 format is adopted, the sub sampler 124 converts a YCbCr image having a 4:4:4 format into a YCbCr image having a 4:2:0 format. The YCbCr encoder 126 encodes the YCbCr image having the 4:2:0 format received from the sub sampler 124. The YCbCr encoder 126 may be an MPEG 2-based or H.264-based encoder.

The decoding apparatus 140 includes a YCbCr decoder 142, an up sampler 144, and a second format converter 146.

The YCbCr decoder 142 decodes a received stream and outputs a decoded YCbCr image. The YCbCr decoder 142 may be an MPEG 2-based or H.264-based decoder. If the decoded YCbCr image is a YCbCr image having a 4:2:0 format, the decoded YCbCr image is converted into a YCbCr image having a 4:4:4 format. The second format converter 146 converts the YCbCr image having the 4:4:4 format into an RGB image having a 4:4:4 format and outputs the RGB image having the 4:4:4 format to a display unit (not shown).

Since the related art moving-picture codec is based on YCbCr images, RGB images must be converted into YCbCr images and accordingly the amount of conversion calculations is increased. Also, when RGB images are converted into YCbCr images and the YCbCr images are encoded, high quality images cannot be provided.

Meanwhile, as IEEE 802.11x standards, IEEE 802.16x standards, etc., which are wireless transmission/reception technologies, have been developed, wireless reception and transmission of high definition (HD)-level moving pictures have been combined with consumer electronics (CE) products. In particular, an 802.11-series wireless local area network (WLAN) technology, which is a WiFi technology, achieves a maximum rate of 400 Mbps and achieves low-compression and high definition transmission/reception.

Accordingly, a high definition moving picture transmission/reception system, in which an image codec capable of providing high definition images combined with a recently developed wireless transmission/reception technique, is required.

### SUMMARY OF THE INVENTION

The present invention provides an RGB codec-based moving picture transmitting and receiving method and apparatus.

According to an aspect of the present invention, there is provided an RGB codec-based moving picture transmitting method including: performing RGB-encoding on an RGB image and generating an encoded RGB image; receiving an audio bit stream; and generating a transmission stream on the basis of the encoded RGB image and the audio bit stream, wherein the RGB-encoding is performed using intra prediction or inter prediction for encoding a current image on the basis of a previous RGB image.

The method further includes: receiving an image stream having a format different from a format of the RGB image; and converting the format of the image stream into a format of an RGB image.

The image stream is a YCbCr-based transmission stream, and the converting of the format of the image stream includes: decoding the YCbCr-based transmission stream; and converting the decoded YCbCr-based transmission stream into an RGB image.

The method further includes: receiving a transmission stream based on a predetermined codec which is different from the RGB codec; and multiplexing the generated transmission stream with the received transmission stream and transmitting the result of the multiplexing.

According to another aspect of the present invention, there is provided an RGB codec-based moving picture transmitting apparatus including: an RGB encoding unit performing RGB-encoding on an RGB image and generating an encoded RGB image; an audio bit stream receiving unit receiving an audio bit stream; and a transmission stream generating unit generating a transmission stream on the basis of the encoded RGB image and the audio bit stream, wherein the RGB encoding unit comprises an intra prediction and inter prediction unit performing intra prediction or inter prediction for RGB-encoding a current image on the basis of a previous RGB image.

The apparatus further includes: a receiver receiving an image stream having a format different from a format of the RGB image; and an RGB image conversion unit converting the format of the image stream into a format of an RGB image.

The image stream having the format different from the format of the RGB image is a YCbCr-based transmission stream, and the RGB format image conversion unit includes: a YCbCr decoding unit decoding the YCbCr-based transmission stream; and a format conversion unit converting the decoded YCbCr-based transmission stream into an RGB image.

According to another aspect of the present invention, there is provided an RGB codec-based moving picture transmitting method including: determining whether an input image is an image having an RGB format; selectively converting the input image into an RGB image according to the determination result, and storing the input image or the converted image; performing RGB-encoding on the stored image; and generating a transmission stream on the basis of the RGB-encoded image and transmitting the transmission stream, wherein the RGB-encoding is performed using intra prediction or inter prediction for RGB-encoding a current image on the basis of a previous RGB image.

The input image is a YCbCr-based transmission stream, and the method for converting the input image into the RGB image includes: decoding the YCbCr-based transmission stream; and converting the decoded YCbCr image into the RGB image.

According to another aspect of the present invention, there is provided an RGB codec-based moving picture transmitting apparatus including: a determination unit determining whether an input image is an image having an RGB format; an RGB image conversion unit selectively converting the input image into an RGB image according to the determination result; an image storage unit storing the input image or the converted image; an RGB encoding unit performing RGB-encoding on the stored image; and a transmission stream generating and transmitting unit generating a transmission stream on the basis of the RGB-encoded image, and transmitting the generated transmission stream, wherein the RGB encoding unit comprises an intra prediction and inter prediction unit performing intra prediction or inter prediction for RGB-encoding a current image on the basis of a previous RGB image.

According to another aspect of the present invention, there is provided an RGB codec-based moving picture receiving method including: receiving a transmission stream including an encoded RGB image and an audio bit stream and extracting the encoded RGB image from the transmission stream; and performing decoding on the encoded RGB image, wherein the decoding of the encoded RGB image is performed using inter prediction or intra prediction for decoding a current image on the basis of a previously decoded RGB image.

According to another aspect of the present invention, there is provided an RGB codec-based moving picture receiving apparatus including: an extracting unit receiving a transmission stream including an encoded RGB image and an audio bit stream, and extracting the encoded RGB image from the transmission stream; and

an RGB decoding unit performing decoding on the encoded RGB image, wherein the RGB decoding unit performs inter prediction or intra prediction for decoding a current image on the basis of a previously decoded RGB image.

According to another aspect of the present invention, there is provided an RGB codec-based moving picture receiving method including: receiving a bit stream including an RGB codec-based transmission stream consisting of an encoded RGB image and a transmission stream based on a codec different from the RGB codec; extracting the RGB codec-based transmission stream and the transmission stream based on the codec different from the RGB codec, from the bit stream; and determining whether the extracted transmission stream is an RGB codec-based transmission stream or an transmission stream based on the codec different from the RGB codec, and selectively performing RGB-decoding or decoding corresponding to the predetermined codec different from the RGB codec, according to the determination result, wherein the RGB-decoding is performed using inter prediction or intra prediction for decoding a current image on the basis of a previously decoded RGB image.

According to another aspect of the present invention, there is provided an RGB codec-based moving picture receiving apparatus including: a receiver receiving a bit stream including an RGB codec-based transmission stream consisting of an encoded RGB image and a transmission stream based on a codec different from the RGB codec; an extractor extracting the RGB codec-based transmission stream and the transmission stream based on the codec different from the RGB codec, from the bit stream; and a decoding unit determining whether the extracted transmission stream is an RGB codec-based transmission stream or a transmission stream based on the codec different from the RGB codec, and selectively performing RGB decoding or decoding corresponding to the codec different from the RGB codec, according to the determination result, wherein the decoding unit performs the RGB decoding using inter prediction or intra prediction for decoding a current image on the basis of a previously decoded RGB image.

According to another aspect of the present invention, there is provided a computer-readable recording medium having embodied thereon a program for executing a moving picture transmitting method including: performing RGB-encoding on an RGB image and generating an encoded RGB image; receiving an audio bit stream; and generating a transmission stream on the basis of the encoded RGB image and the audio bit stream, wherein the RGB-encoding is performed using intra prediction or inter prediction for RGB-encoding a current image on the basis of a previous RGB image.

According to another aspect of the present invention, there is provided a computer-readable recording medium having embodied thereon a program for executing a moving picture transmitting method including: determining whether an input image is an image having an RGB format; selectively converting the input image into an RGB image, according to the determination result, and storing the input image or the converted image; performing RGB-encoding on the stored image; and generating a transmission stream on the basis of the RGB-encoded image and transmitting the transmission stream, wherein the RGB encoding is performed using inter prediction or inter prediction for RGB-encoding a current image on the basis of a previous RGB image.

According to another aspect of the present invention, there is provided a computer-readable recording medium having embodied thereon a program for executing a moving picture receiving method including: extracting an encoded RGB image from a transmission stream including an encoded RGB image and an audio bit stream; and performing decoding on the encoded RGB image, wherein the RGB decoding is performed using inter prediction or intra prediction for decoding a current image on the basis of a previously decoded RGB image.

According to another aspect of the present invention, there is provided a computer-readable recording medium having embodied thereon a program for executing a moving picture receiving method including: receiving a bit stream including an RGB codec-based transmission stream consisting of an encoded RGB image and a transmission stream based on a predetermined codec different from the RGB codec; extracting the RGB codec-based transmission stream and the transmission stream based on the predetermined codec different form the RGB codec, from the bit stream; and determining whether the extracted transmission stream is an RGB codec-based transmission stream or a transmission stream based on a predetermined codec different from the RGB codec, and selectively performing RGB-decoding or decoding corresponding to the predetermined codec different from the RGB codec, according to the determination result, wherein the RGB-decoding is performed using inter prediction or intra prediction for decoding a current image on the basis of a previously decoded RGB image.

### BRIEF DESCRIPTION OF THE DRAWINGS

The above and aspects of the present invention will become more apparent by describing in detail exemplary embodiments thereof with reference to the accompanying drawings, in which:

FIG. 1 is a block diagram of a related art YCbCr-based moving picture codec system;

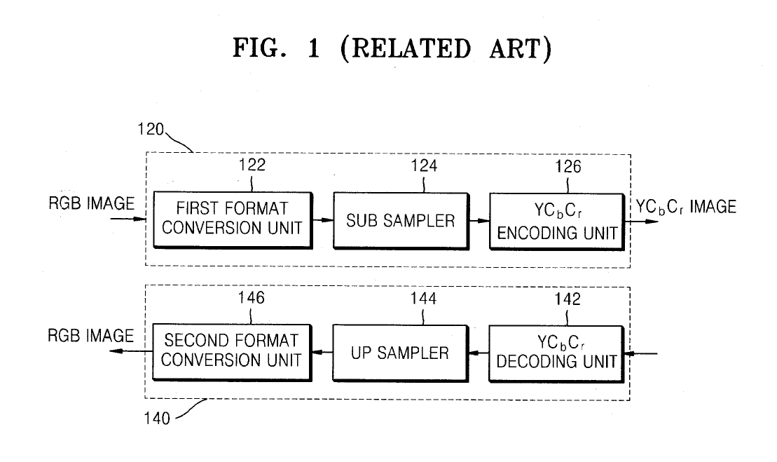

FIG. 2 is a block diagram of an RGB codec-based moving picture transmitting apparatus according to an exemplary embodiment of the present invention;

FIG. 3 is a block diagram of an RGB encoding unit according to an exemplary embodiment of the present invention;

FIG. 4 is a flowchart of an RGB codec-based moving picture transmitting method according to an exemplary embodiment of the present invention;

FIG. 5 is a block diagram of an RGB codec-based moving picture receiving apparatus according to an exemplary embodiment of the present invention;

FIG. 6 is a block diagram of an RGB decoding unit according to an exemplary embodiment of the present invention;

FIG. 7 is a flowchart of an RGB codec-based moving picture receiving method according to an exemplary embodiment of the present invention;

FIG. 8 is a block diagram of an RGB codec-based moving picture transmitting apparatus according to another exemplary embodiment of the present invention;

FIG. 9 is a flowchart of an RGB codec-based moving picture transmitting method according to another exemplary embodiment of the present invention;

FIG. 10 is a block diagram of an RGB codec-based moving picture receiving apparatus according to another exemplary embodiment of the present invention;

FIG. 11 is a flowchart of an RGB codec-based moving picture receiving method according to another exemplary embodiment of the present invention;

FIG. 12 is a block diagram of an RGB codec-based moving picture transmitting apparatus according to another exemplary embodiment of the present invention;

FIG. 13 is a block diagram of an RGB image conversion unit according to an exemplary embodiment of the present invention; and

FIG. 14 is a flowchart of an RGB codec-based moving picture transmitting method according to another exemplary embodiment of the present invention.

### DETAILED DESCRIPTION OF THE EXEMPLARY EMBODIMENTS OF THE INVENTION

Hereinafter, exemplary embodiments of the present invention will be described in detail with reference to the appended drawings.

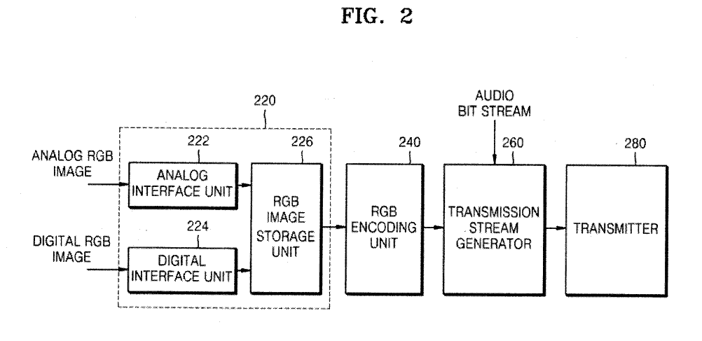

FIG. 2 is a block diagram of an RGB codec-based moving picture transmitting apparatus according to an exemplary embodiment of the present invention.

Referring to FIG. 2, the RGB codec-based moving picture transmitting apparatus includes an RGB encoding unit 240, a transmission stream generator 260, a transmitter 280, and an RGB image input and storage unit 220 including an analog interface 222, a digital interface 224, and an RGB image storage unit 226.

The analog interface 222 receives an analog RGB image and outputs the analog RGB image to the RGB image storage unit 226. The analog RGB image may be composite video, component video, S-video, VESA video, etc.

The digital interface 224 receives a digital RGB image and outputs the digital RGB image to the RGB image storage unit 226. The digital RGB image may be a High Definition Multimedia Interface (HDMI) image, a Transition Minimized Differential Signaling (HMDS) image, or a Low Voltage Differential Signaling (LVDS) image.

The RGB image storage unit 226 stores the analog RGB image or the digital RGB image received from the analog interface 222 or the digital interface 224. The RGB image storage unit 226 may be a synchronous dynamic random access memory (SDRAM), a double data rate SDRAM (DDR SDRAM), a double data rate 2 SDRAM (DDR2 SDRAM), a static random access memory (SRAM), or a volatile memory device such as a register. Also, the RGB image storage unit 226 may be a non-volatile memory device, such as a hard disc or a flash memory. The RGB image storage unit 226 outputs the stored analog RGB image or the stored digital RGB image to the RGB encoding unit 240.

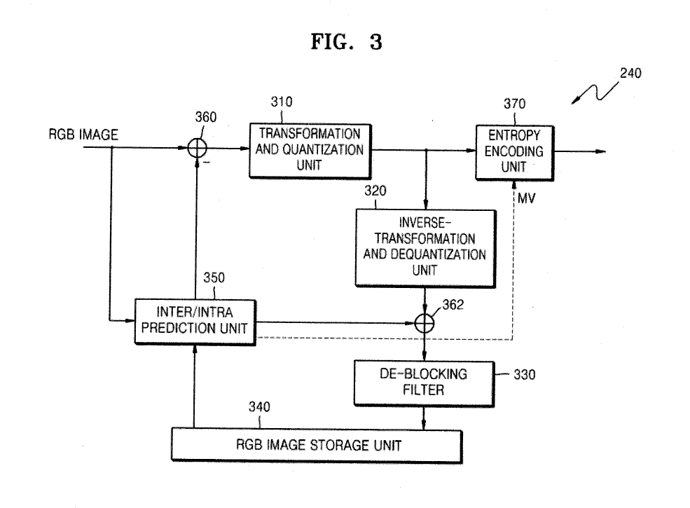

The RGB encoding unit 240 performs encoding on the received analog RGB image or the received digital RGB image, and outputs an encoded bit stream to the transmission stream generator 260. The RGB encoding unit 240 will be described in detail later with reference to FIG. 3.

The transmission stream generator 260 performs multiplexing on the encoded bit stream received from the RGB encoding unit 240 and an audio bit stream received from the outside, generates a transmission stream, and then outputs the transmission stream to the transmitter 280.

The transmitter 280 transmits the transmission stream. In the exemplary embodiment, the transmitter 280 is a wireless transmission module based on the 802.11 in standard which is a wireless transmission and reception standard. However, the transmitter 280 may be an arbitrary transmission device that can selectively transmit transmission streams.

FIG. 3 is a block diagram of the RGB encoding unit 240 illustrated in FIG. 2.

Referring to FIG. 3, the RGB encoding unit 240 includes a transformation and quantization unit 310, an inverse-transformation and dequantization unit 320, a de-blocking filter 330, an RGB image storage unit 340, an inter/intra prediction unit 350, a first adder 360, a second adder 362, and an entropy encoding unit 370.

The transformation and quantization unit 310 transforms received image data to remove spatial redundancy of the image data. In addition, transform coefficients obtained by transformation and encoding are quantized according to a quantization method, and N×M data that is two-dimensional data consisting of the quantized transform coefficients is obtained. The image conversion used may be Discrete Cosine Transformation (DCT).

The inverse-transformation and dequantization unit 320 dequantizes the image data quantized by the transformation and quantization unit 310, and performs inverse image conversion (for example, inverse-DCT) on the dequantized image data.

The second adder 362 adds a prediction image output from the inter/intra prediction unit 350 with data restored by the inverse-transformation and dequantization unit 320, and generates a restored image.

The de-blocking filter 330 performs filtering on the restored image and outputs the result of the filtering to the RGB storage unit 340, in order to remove a blocking phenomenon that is caused by quantization, from the restored image output from the second adder 362. If desired, the de-blocking filter 330 may be omitted.

The RGB image storage unit 340 stores the image data inverse-transformed and dequantized by the inverse-transformation and dequantization unit 320, or the image data filtered by the de-blocking filter 330, in a unit of a frame. The RGB image storage unit 340 may be an SDRAM, a DDR SDRAM, a DDR2 SDRAM, an SRAM, or a register. The restored RGB image stored in the RGB image storage unit 340 is delayed by a period of time, and then output and used for inter prediction or intra prediction.

The inter/intra prediction unit 350 includes an intra prediction unit and a motion prediction and compensation unit (not shown).

In the case of an intra macroblock, the intra prediction unit obtains a predictor for each block or for each macroblock in a spatial area, and outputs the predictor to the first adder 360.

The motion prediction and compensation unit predicts a motion vector MV for each macroblock, using image data of a current input frame and image data of the previous frame stored in the RGB image storage unit 340. Also, a prediction area P motion-compensated on the basis of the predicted motion vector MV, for example, a 16×16 area selected by motion prediction, is generated and output to the adder 360. The RGB encoding unit 240 selects one of an inter mode or an intra mode in a unit of a block, for example, in a unit of a macroblock.

The adder 360 transmits difference information between the original RGB image and the predictor output from the inter/intra prediction unit 350, to the transformation and quantization unit 310, in a unit of a predetermined block.

The entropy encoder 370 receives information about the motion vector MV output from the motion prediction and compensation unit and the quantized transform coefficients output from the transformation and quantization unit 310, entropy-encodes the information, and finally outputs an encoded bit stream.

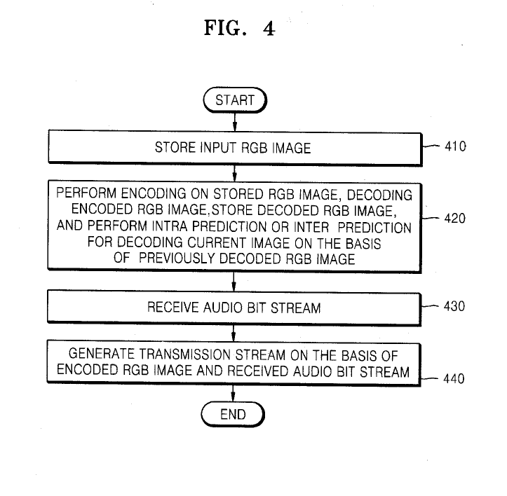

FIG. 4 is a flowchart of an RGB codec-based moving picture transmitting method according to an exemplary embodiment of the present invention that is performed by the RGB codec-based moving picture transmitting apparatus illustrated in FIG. 2.

Referring to FIG. 4, in operation 410, an input RGB image is stored. In more detail, if an input RGB image is an analog RGB image, the analog RGB image is stored in the form of RGB without any format conversion, via an analog interface. On the other hand, if the input RGB image is a digital RGB image, the digital RGB image is stored in the form of RGB without any format conversion, via a digital interface.

Then, in operation 420, the input RGB image stored in operation 410 is RGB-encoded and the encoded RGB image is decoded. The resultant decoded RGB image is stored, and intra prediction or inter prediction for encoding a current RGB image is performed on the basis of the previously restored RGB image.

In operation 430, an audio bit stream is received.

In operation 440, the encoded RGB image is multiplexed with the audio bit stream, so that a transmission stream is generated and transmitted.

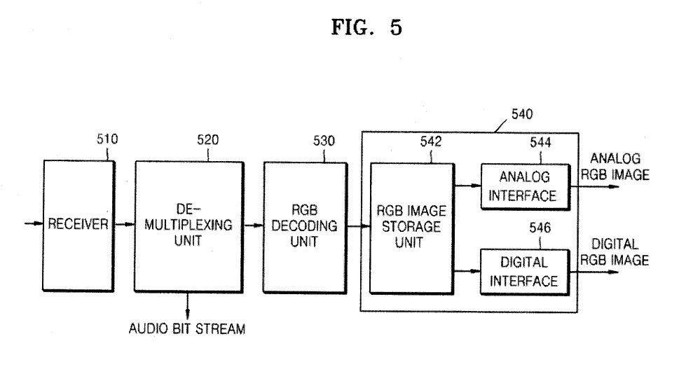

FIG. 5 is a block diagram of an RGB codec-based moving picture receiving apparatus according to an exemplary embodiment of the present invention.

Referring to FIG. 5, the RGB image decoding apparatus includes a receiver 510, a de-multiplexing unit 520, an RGB decoding unit 530, and a decoded RGB image storage and output unit 540 including an RGB storage unit 542, an analog interface 544, and a digital interface 546.

The receiver 510 receives the transmission stream consisting of the encoded RGB image and the audio stream.

The de-multiplexing unit 520 performs demultiplexing on the transmission stream and extracts the encoded RGB image and the audio stream from the transmission stream. The extracted RGB image is output to the RGB decoding unit 530.

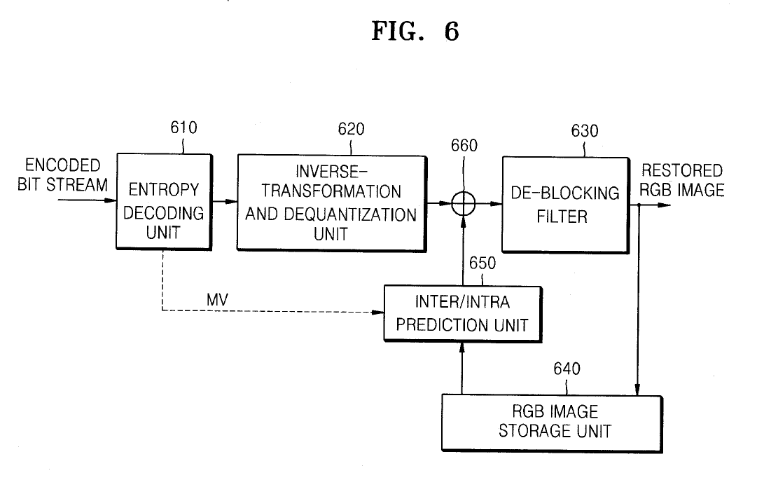

The RGB decoding unit 530 receives, decodes, and outputs the encoded RGB image. The RGB decoding unit 530 will be described later with reference to FIG. 6.

The RGB storage unit 542 stores the restored RGB image output from the RGB decoding unit 530. In the current exemplary embodiment, the stored RGB image is delayed by a period of time and output to the analog interface 544 and the digital interface 546.

The RGB storage unit 542 may be an SDRAM, a DDR SDRAM, a DDR2 SDRAM, an SRAM, or a volatile memory such as a register. Also, the RGB storage unit 542 may be a non-volatile memory device, such as a hard disc or a flash memory. The RGB storage unit 542 selectively outputs the stored analog RGB image or the stored digital RGB image to the analog interface 544 or the digital interface 546, respectively.

The analog interface 544 receives the analog RGB image and outputs the analog RGB image to a display unit (not shown). The analog RGB image may be composite video, component video, S-video, VESA video, etc.

The digital interface 546 receives the digital RGB image and outputs the digital RGB image to a display unit (not shown). The digital RGB image may be an HDMI image.

FIG. 6 is a block diagram of the RGB decoding unit 530 illustrated in FIG. 5.

Referring to FIG. 6, the RGB decoding unit 530 includes an entropy decoder 610, an inverse-transformation and dequantization unit 620, a de-blocking filter 630, an RGB image storage unit 640, an inter/intra prediction unit 650, and an adder 660.

The entropy decoder 610 entropy-decodes an encoded input stream and extracts image data, a motion vector, etc., from the input stream. The entropy-decoded image data is transferred to the inverse-transformation and dequantization unit 620, and motion vector information is transferred to the inter/intra prediction unit 650.

The inverse-transformation and dequantization unit 620 performs inverse-transformation and dequantization on the image data extracted by the entropy decoder 610.

The de-blocking filter 630 performs filtering on the inverse-transformed and dequantized image data and outputs the result of the filtering to the RGB storage unit 640 and a display unit (not shown), in order to remove a blocking phenomenon, which is caused by quantization, from a restored image generated by the second adder 660. If desired, the de-blocking filter 630 can be omitted.

The RGB image storage unit 640 stores the image data inverse-transformed and dequantized by the inverse-transformation and dequantization unit 620 or the data filtered by the de-blocking filter 630, in a unit of a frame. The RGB image storage unit 640 may be an SDRAM, a DDR SDRAM, a DDR2 SDRAM, an SRAM, or a register. The restored RGB image stored in the RGB storage unit 640 is delayed by a predetermined time and then output and used for inter prediction and intra prediction.

The inter/intra prediction unit 650 includes an intra prediction unit (not shown) and a motion prediction and compensation unit (not shown).

In the case of an intra macroblock, the intra prediction unit obtains a predictor for each block or for each macroblock in a spatial area, and outputs the predictor to the adder 660. The motion prediction and compensation unit generates a prediction area P, for example, a 16×16 area selected by motion prediction, on the basis of the extracted motion vector and the previous frame image received from the RGB image storage unit 640.

The adder 660 adds the RGB image decoded by the inverse-transformation and dequantization unit 620 with the predictor output from the inter/intra prediction unit 650 in order to restore the RGB image, and outputs the restored RGB image directly to a display unit (not shown) and the RGB image storage unit 640 or to the display unit (not shown) and the RGB image storage unit 640 via the de-blocking filter 630.

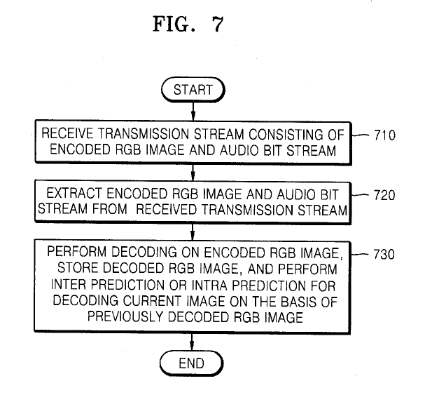

FIG. 7 is a flowchart of an RGB codec-based moving picture receiving method according to an exemplary embodiment of the present invention, which is performed by the RGB codec-based moving picture receiving apparatus illustrated in FIG. 5.

In operation 710, a transmission stream consisting of an encoded RGB image and an audio bit stream is received.

In operation 720, the encoded RGB image and the audio bit stream are extracted from the transmission stream.

In operation 730, decoding is performed on the extracted encoded RGB image, the decoded RGB image is stored, and inter prediction or intra prediction for decoding a current RGB image is performed on the basis of the previously decoded RGB image. In more detail, the decoded RGB image is delayed by a period of time, and then output via an analog interface or via a digital interface.

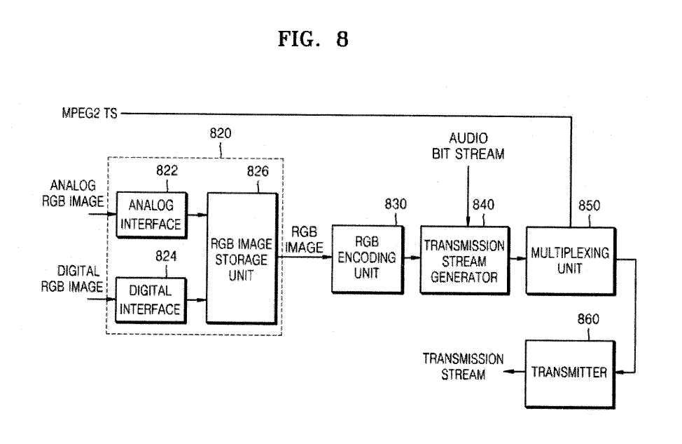

FIG. 8 is a block diagram of an RGB codec-based moving picture transmitting apparatus according to another exemplary embodiment of the present invention.

Referring to FIG. 8, the RGB codec-based moving picture transmitting apparatus includes an RGB encoding unit 830, a transmission stream generator 840, a multiplexing unit 850, a transmitter 860, and an RGB image input and storage unit 820 including an analog interface 822, a digital interface 824, and an RGB image storage unit 826.

The analog interface 822 receives an analog RGB image and outputs the analog RGB image to the RGB image storage unit 826. The analog RGB image may be composite video, component video, S-video, VESA video, etc.

The digital interface 824 receives a digital RGB image and outputs the digital RGB image to the RGB image storage unit 826. The digital RGB image may be an HDMI image, a TMDS image, or an LVDS image.

The RGB image storage unit 826 stores an analog RGB image or a digital RGB image received through the analog interface 822 or the digital interface 824. The RGB image storage unit 826 may be an SDRAM, a DDR SDRAM, a DDR2 SDRAM, an SRAM, or a volatile memory such as a register. Also, the RGB image storage unit 826 may be a non-volatile memory device, such as a hard disc or a flash memory. The RGB image storage unit 824 outputs the stored analog RGB image or the stored digital RGB image to the RGB encoding unit 830.

The RGB encoding unit 830 encodes the analog RGB image or the digital RGB image, and outputs an encoded bit stream. The RGB encoding unit 830 is illustrated in FIG. 3 and accordingly a detailed description thereof will be omitted.

The transmission stream generator 840 performs multiplexing on the encoded RGB image received from the RGB encoding unit 830 and an audio bit stream received from the outside, and outputs the result of the multiplexing in the format of a transmission stream to the multiplexing unit 850. Selectively, the transmission stream generator 840 can generate a transmission stream using only the encoded RGB image and output the transmission stream to the multiplexing unit 850.

Meanwhile, if the RGB codec-based moving picture transmitting apparatus receives an MPEG2-based transmission stream, the RGB codec-based moving picture transmitting apparatus bypasses the MPEG2-based transmission stream to the multiplexing unit 850.

The multiplexing unit 850 performs multiplexing on the transmission stream consisting of the received MPEG2-based transmission stream, the encoded RGB image, and the audio bit stream, which are received from the transmission stream generator 840, and outputs the result of the multiplexing to the transmitter 860. In the current exemplary embodiment, the received transmission stream is an MPEG2-based transmission stream. However, the received transmission stream may be an arbitrary codec-based transmission stream, for example, a YCbCr-based transmission stream.

The transmitter 860 transmits the received transmission stream. In the current exemplary embodiment, the transmitter 860 is a wireless transmission module based on the 802.11n standard. However, the transmitter 860 may be an arbitrary transmission device which transmits transmission streams.

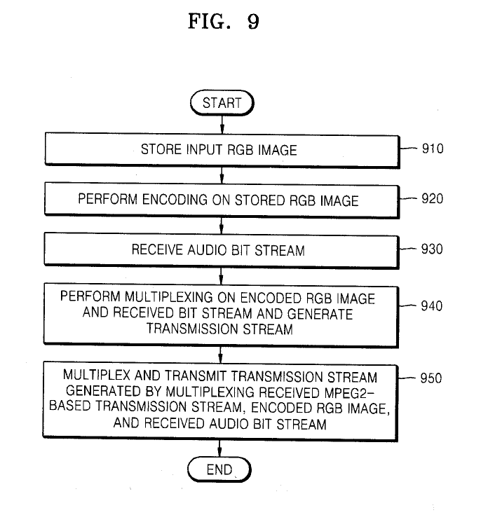

FIG. 9 is a flowchart of a moving picture transmitting method according to another exemplary embodiment of the present invention, which is performed by the RGB codec-based moving picture transmitting device illustrated in FIG. 8.

In operation 910, an RGB image is received and stored. In more detail, if the RGB image is an analog RGB image, the analog RGB image is stored in the form of RGB without any format conversion, via an analog interface. Also, if the received RGB image is a digital RGB image, the digital RGB image is stored in the form of RGB without any format conversion, via a digital interface.

In operation 920, the RGB image stored in operation 910 is encoded and the encoded RGB image is decoded. Then, the decoded RGB image is stored, and intra prediction or inter prediction for encoding a current RGB image is performed on the basis of the previously decoded RGB image.

In operation 930, an audio bit stream is received.

In operation 940, the encoded RGB image and the audio bit stream are multiplexed, so that a transmission stream is generated. Selectively, the operation 930 of receiving the audio bit stream can be omitted. In this case, in operation 940, the transmission stream is generated using only the encoded RGB image.

In operation 950, an MPEG2-based transmission stream is received, the transmission stream generated in operation 940 is multiplexed with the MPEG2-based transmission stream, and the result of the multiplexing is transmitted. In the current exemplary embodiment, an MPEG2-based transmission stream is received. However, the present invention is not limited to an MPEG2-based transmission stream. An arbitrary codec-based transmission stream, for example, a YCbCr Codec-based transmission stream can be received.

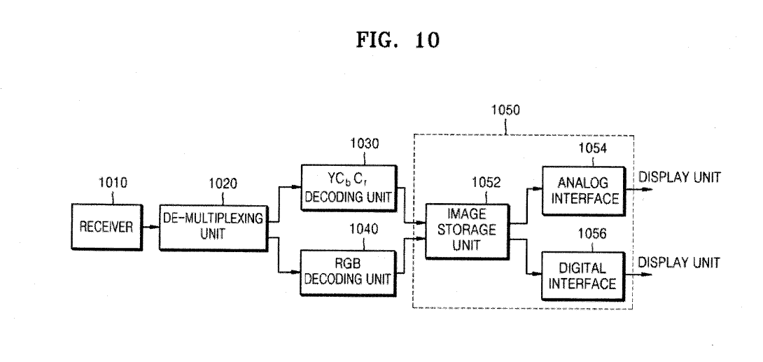

FIG. 10 is a block diagram of an RGB codec-based moving picture receiving apparatus according to another exemplary embodiment of the present invention.

Referring to FIG. 10, the RGB codec-based moving picture receiving apparatus includes a receiver 1010, a de-multiplexing unit 1020, a YCbCr decoding unit 1030, an RGB decoding unit 1040, and an encoded RGB image storage and output unit 1050 including an image storage unit 1052, an analog interface 1054, and a digital interface 1056.

The receiver 1010 receives a transmission stream consisting of an encoded RGB image, an audio stream, and an MPEG2-based transmission stream.

The de-multiplexing unit 1020 performs de-multiplexing on the transmission stream and extracts the MPEG2-based transmission stream and an RGB-based transmission stream consisting of the encoded RGB image and the audio stream, from the transmission stream. Also, the de-multiplexing unit 1020 extracts the audio stream from the extracted RGB-based transmission stream. The extracted MPEG2-based transmission stream is output to the YCbCr decoding unit 1030, and an RGB image bit stream of the extracted RGB-based transmission stream is output to the RGB decoding unit 1040. Also, the RGB-based transmission stream can consist of only an encoded RGB image. In this case, the process of extracting the audio stream from the RGB-based transmission stream is omitted.

The YCbCr decoding unit 1030 decodes the MPEG2-based transmission stream and outputs the resultant restored YCbCr image to the image storage unit 1050. In the current exemplary embodiment, the YCbCr-based transmission stream is an MPEG2-based transmission stream, and the YCbCr decoding unit 1030 is an MPEG2-based decoding device. Selectively, the YCbCr-based transmission stream may be an arbitrary codec-based transmission stream, and the YCbCr decoding unit 1030 may be a decoding apparatus corresponding to the arbitrary codec.

The RGB decoding unit 1040 is described above with reference to FIG. 6, and accordingly a detailed description thereof will be omitted. The RGB decoding unit 1040 decodes and outputs the encoded RGB image.

The image storage unit 1052 stores the YCbCr image output from the YCbCr decoding unit 1030 and the restored RGB image output from the RGB decoding unit 1040. In the current exemplary embodiment, the stored YCbCr and RGB images are delayed for a period of time, and then output to the analog interface 1054 and the digital interface 1056.

The image storage unit 1052 may be an SDRM, a DDR SDRAM, a DDR2 SDRAM, an SRAM, or a volatile memory device such as a register. Also, the image storage unit 1052 may be a non-volatile memory device, such as a hard disc or a flash memory. The image storage unit 1052 selectively outputs the stored analog RGB image or the stored digital RGB image to the analog interface 1054 or the digital interface 1056 respectively.

The analog interface 1054 receives an analog RGB image and outputs the analog RGB image to a display unit (not shown). The analog RGB image may be composite video, component video, S-video, VESA video, etc.

The digital interface 1056 receives a digital RGB image and outputs the digital RGB image to the display unit. The digital RGB image may be an HDMI image, a TMDS image, or an LVDS image.

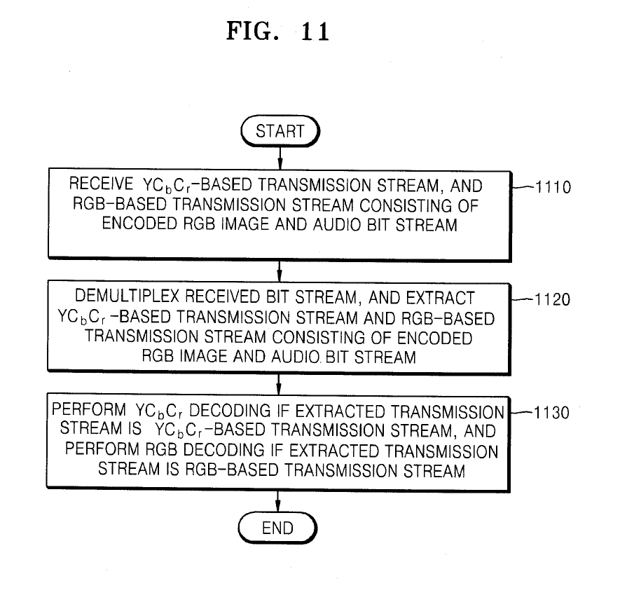

FIG. 11 is a flowchart of a moving picture receiving method according to another exemplary embodiment of the present invention, which is performed by the RGB codec-based moving picture receiving apparatus illustrated in FIG. 10.

In operation 1110, an YCbCr-based transmission stream and an RGB-based transmission stream consisting of an encoded RGB image and an audio bit stream are received. Selectively, the RGB-based transmission stream may consist of only an encoded RGB image.

In operation 1120, the received bit stream is demultiplexed, so that the YCbCr-based transmission stream and the RGB-based transmission stream consisting of the encoded RGB image and the audio bit stream are extracted. The encoded RGB image and the audio bit stream are extracted from the RGB-based transmission stream.

In operation 1130, if the extracted transmission stream is a YCbCr-based transmission stream, YCbCr decoding is performed. If the extracted transmission stream is an RGB-based transmission stream, RGB decoding is performed and the decoded image is stored. In more detail, the decoded YCbCr image is delayed for a period of time and then output via an analog interface or via a digital interface.

As described above, if the extracted transmission stream is an RGB-based transmission stream, RGB decoding is performed and the decoded image is stored. Here, inter prediction or intra prediction for decoding a current image is performed on the basis of the previously decoded RGB image. In more detail, the decoded RGB image is delayed for a period of time and then output via an analog interface or via a digital interface.

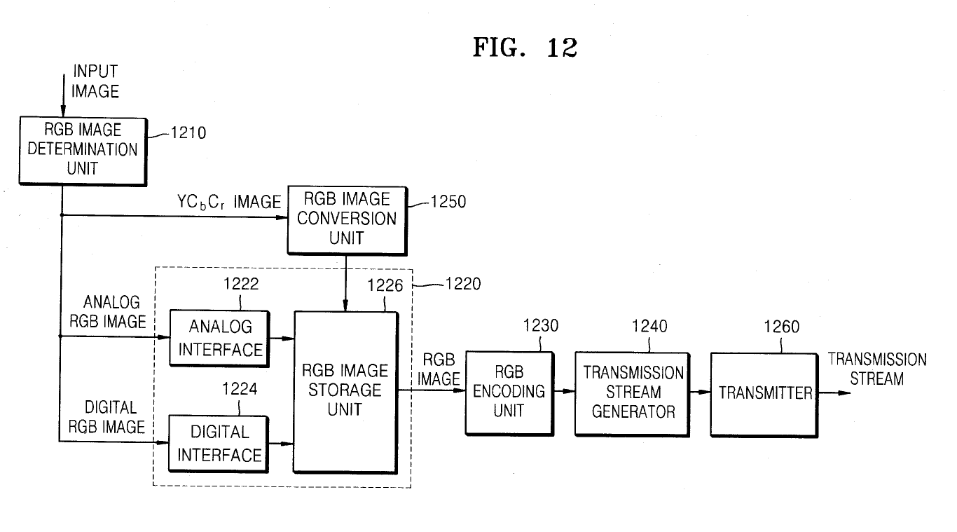

FIG. 12 is a block diagram of an RGB codec-based moving picture transmitting apparatus according to another exemplary embodiment of the present invention.

Referring to FIG. 12, the RGB codec-based moving picture transmitting apparatus includes an RGB encoding unit 1230, a transmission stream generator 1240, an RGB image conversion unit 1250, a transmitter 1260, and an RGB image input and storage unit 1220 including an analog interface 1222, a digital interface 1224, and an RGB image storage unit 1226. The RGB codec-based moving picture transmitting apparatus can further include an RGB image determination unit 1210 which determines whether an input image is an RGB image.

Since the analog interface 1222, the digital interface 1224, the RGB encoding unit 1230, the transmission stream generator 1240, and the transmitter 1260 perform the same functions as the corresponding units illustrated in FIG. 8, detailed descriptions thereof will be omitted.

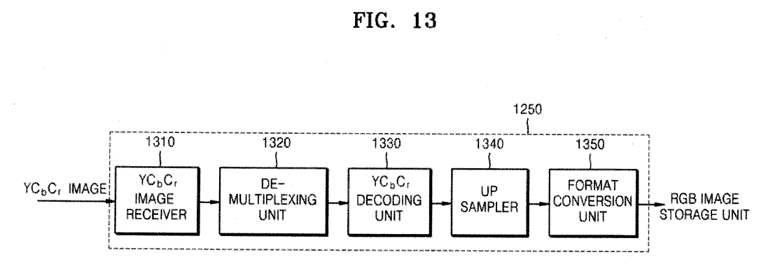

If an input image is not an RGB image, the RGB image conversion unit 1250 converts the input image into an RGB image and outputs the result of the conversion to the RGB image storage unit 1226. FIG. 13 is a block diagram of the RGB image conversion unit 1250 according to an exemplary embodiment of the present invention.

Referring to FIG. 13, the RGB image conversion unit 1250 includes a YCbCr image receiver 1310, a de-multiplexing unit 1320, a YCbCr decoding unit 1330, an up-sampler 1340, and a format conversion unit 1350.

The YCbCr image receiver 1310 receives a bit stream including a YCbCr-based image stream. The YCbCr image receiver 1310 may be a demodulator and a tuner for digital TVs, and the YCbCr-based image stream may be an MPEG2-based video stream.

The de-multiplexing unit 1320 de-multiplexes an image stream from the received bit stream and outputs the result of the de-multiplexing to the YCbCr decoding unit 1330.

The YCbCr decoding unit 1330 decodes the received image stream and generates a restored YCbCr image. In the current exemplary embodiment, the YCbCr-based image stream is an MPEG2-based transmission stream, and the YCbCr decoding unit 1330 is an MPEG2-based decoding device. Selectively, the received transmission stream may be an arbitrary codec-based transmission stream, and the YCbCr decoding unit 1030 may be a decoding apparatus corresponding to the arbitrary codec.

If the YCbCr image decoded by the YCbCr decoding unit 1330 is a YCbCr image with a 4:2:0 format, the up-sampler 1340 converts the YCbCr image with the 4:2:0 format into a YCbCr image with a 4:4:4 format.

The format converter 1350 converts the YCbCr image having the 4:4:4 format into an RGB image having a 4:4:4 format, and then outputs the RGB image having the 4:4:4 format to the RGB image storage unit 1224.

If an input image is an analog RGB image, the analog interface 1222 receives the analog RGB image and outputs the analog RGB image to the RGB image storage unit 1226.

If an input image is a digital RGB image, the digital interface 1224 receives the digital RGB image and outputs the digital RGB image to the RGB image storage unit 1226.

The RGB image storage unit 1226 stores the analog RGB image or the digital RGB image received from the analog interface 1222 or digital interface 1224, and the RGB image conversion unit 1250.

The RGB storage unit 1226 outputs the stored analog RGB image or the stored digital RGB image to the RGB encoding unit 1230.

The RGB encoding unit 1230 encodes the analog RGB image or digital RGB image and outputs an encoded bit stream. The RGB encoding unit 1230 is described above with reference to FIG. 3, and accordingly a detailed description thereof will be omitted.

The transmission stream generator 1240 performs multiplexing on the encoded RGB image output from the RGB encoding unit 1230 and an audio bit stream received from the outside, and transmits the result of the multiplexing in the format of a transmission stream to the transmitter 1260. If desired, only the encoded RGB image can be output in the format of a transmission stream.

The transmitter 1260 transmits the transmission stream.

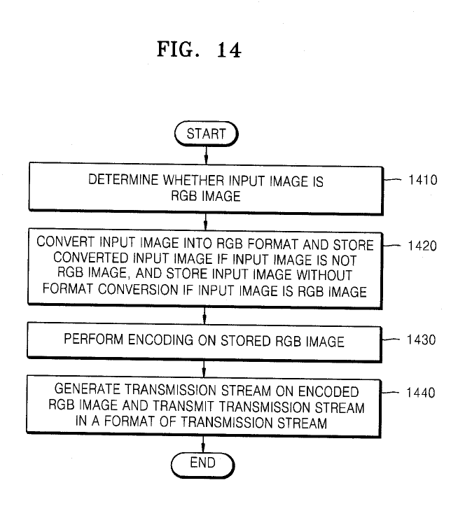

FIG. 14 is a flowchart of a moving picture transmitting method according to another exemplary embodiment of the present invention, which is performed by the RGB codec-based moving picture apparatus illustrated in FIG. 12

In operation 1410, it is determined whether an input image is an RGB image.

In operation 1420, if the input image is not an RGB image, the input image is converted into RGB format, and if the input image is an RGB image, the input image is stored without any format conversion.

In operation 1430, RGB-encoding is performed on the RGB image stored in operation 1320. Here, the encoded RGB image is decoded after the RGB-encoding, then the decoded RGB image is stored, and intra prediction or inter prediction for encoding a current image is performed on the basis of the previously restored RGB image.

In operation 1440, a transmission stream is generated on the basis of the encoded RGB image. Selectively, an audio bit stream may be received from the outside, and the received audio bit stream may be multiplexed with the encoded RGB image, so that a transmission stream is generated.

The RGB codec-based moving picture transmitting apparatus can predict the current available channel capacity of a transmitter terminal (for example, a wireless transmitter side). For example, if a wireless transmitter is a WLAN, the RGB codec-based moving picture transmitting apparatus can calculate the bandwidth of data transmittable without any channel error, wherein the bandwidth information can be available bit-rate information of an RGB encoder side. If the distance between a receiver terminal and a transmitter terminal, as a factor that can influence a channel bandwidth, increases, or if an obstacle is generated between a transmitter terminal and a receiver terminal, the bandwidth can be reduced.

Accordingly, the predicted channel capacity is transmitted to the RGB encoding unit in the respective exemplary embodiments of the present invention, and the RGB encoding unit can control a bit rate according to the channel capacity received through an internal rate controller. For example, if channel capacity is reduced to 70 Mbps while encoding is performed at 100 Mbps, information indicating a fact that channel capacity is reduced to 70 Mbps is transmitted to the RGB encoding unit, and thus encoding is performed to be suitable for a channel capacity of 70 Mbps through the rate controller without serious degradation of picture quality.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, in the RGB codec-based moving picture transmitting and receiving method according to the present invention, since encoding and decoding of input images are performed without any color format conversion, picture quality does not deteriorate. Also, if an image input to the RGB codec-based moving picture receiving and transmitting apparatus is not an RGB image, since the image is converted into an RGB image and subjected to RGB-encoding and then transmitted, a decoding apparatus can restore the received image using only an RGB decoder. Accordingly, the configuration of the decoding apparatus can be simplified.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. An RGB codec-based moving picture transmitting method comprising:
performing RGB-encoding on an RGB image to generate an encoded RGB image;
receiving an audio bit stream; and
generating a transmission stream based on the encoded RGB image and the audio bit stream,
wherein the RGB-encoding is performed using intra prediction or inter prediction for encoding a current image based on a previous RGB image.

2. The method of claim 1, further comprising:
receiving an image stream having a format different from a format of the RGB image; and
converting the format of the image stream into a format of the RGB image.

3. The method of claim 2, wherein the image stream is a YCbCr-based transmission stream, and
the converting of the format of the image stream comprises:
decoding the YCbCr-based transmission stream; and
converting the decoded YCbCr-based transmission stream into the RGB image.

4. The method of claim 1, further comprising:
receiving a transmission stream based on a codec which is different from the RGB codec; and
multiplexing the generated transmission stream with the received transmission stream and transmitting a result of the multiplexing.

5. An RGB codec-based moving picture transmitting apparatus comprising:
an RGB encoding unit which performs RGB-encoding on an RGB image to generate an encoded RGB image;
an audio bit stream receiving unit which receives an audio bit stream; and
a transmission stream generating unit which generates a transmission stream based on the encoded RGB image and the audio bit stream,
wherein the RGB encoding unit comprises an intra prediction and inter prediction unit which performs intra prediction or inter prediction for RGB-encoding a current image based on a previous RGB image.

6. The apparatus of claim 5, further comprising:
an RGB image conversion unit comprising a receiver which receives an image stream having a format different from a format of the RGB image;
wherein the RGB image conversion unit converts the format of the image stream into a format of the RGB image.

7. The apparatus of claim 6, wherein the image stream having the format different from the format of the RGB image is a YCbCr-based transmission stream, and
the RGB image conversion unit further comprises:
a YCbCr decoding unit which decodes the YCbCr-based transmission stream; and
a format conversion unit which converts the decoded YCbCr-based transmission stream into an RGB image.

8. The apparatus of claim 5, further comprising:
a multiplexing unit which multiplexes the generated transmission stream with a received transmission stream based on a codec which is different from an RGB codec, and transmits a result of the multiplexing.

9. An RGB codec-based moving picture transmitting method comprising:
determining whether an input image is an image having an RGB format;
selectively converting the input image into an RGB image according to a result of the determining;
storing the input image or the converted image;
performing RGB-encoding on the stored image;
generating a transmission stream based on the RGB-encoded image; and
transmitting the transmission stream,
wherein the RGB-encoding is performed using intra prediction or inter prediction for RGB-encoding a current image based on a previous RGB image.

10. The method of claim 9, wherein the input image is a YCbCr-based transmission stream, and
the converting of the input image into the RGB image comprises:
decoding the YCbCr-based transmission stream; and
converting the decoded YCbCr image into the RGB image.

11. An RGB codec-based moving picture transmitting apparatus comprising:
a determination unit which determines whether an input image is an image having an RGB format;
an RGB image conversion unit which selectively converts the input image into an RGB image according to a result of the determination by the determination unit;
an image storage unit which stores the input image or the converted image;
an RGB encoding unit which performs RGB-encoding on the stored image; and
a transmission stream generating and transmitting unit which generates a transmission stream based on the RGB-encoded image, and transmits the generated transmission stream,
wherein the RGB encoding unit comprises an intra prediction and inter prediction unit which performs intra prediction or inter prediction for RGB-encoding a current image based on a previous RGB image.

12. The apparatus of claim 11, wherein the input image is an YCbCr-based transmission stream, and
the RGB image conversion unit comprises:
a YCbCr decoder which decodes the YCbCr-based transmission stream; and
a format conversion unit which converts the decoded YCbCr image into the RGB image.

13. An RGB codec-based moving picture receiving method comprising:
receiving a transmission stream comprising an encoded RGB image and an audio bit stream;
extracting the encoded RGB image from the transmission stream; and
performing decoding on the encoded RGB image,
wherein the decoding of the encoded RGB image is performed using inter prediction or intra prediction for decoding a current image based on a previously decoded RGB image.

14. An RGB codec-based moving picture receiving apparatus comprising:
a receiver which receives a transmission stream comprising an encoded RGB image and an audio bit stream;
a extracting unit which extracts the encoded RGB image from the transmission stream; and
an RGB decoding unit which performs decoding on the encoded RGB image,
wherein the RGB decoding unit performs inter prediction or intra prediction for decoding a current image based on a previously decoded RGB image.

15. An RGB codec-based moving picture receiving method comprising:
receiving a bit stream comprising an RGB codec-based transmission stream comprising an encoded RGB image and a transmission stream based on a codec different from the RGB codec;
extracting the RGB codec-based transmission stream and the transmission stream based on the codec different from the RGB codec, from the bit stream; and
determining whether the extracted transmission stream is an RGB codec-based transmission stream or an transmission stream based on the codec different from the RGB codec; and
selectively performing RGB-decoding or decoding corresponding to the codec different from the RGB codec, according to a result of the determining,
wherein the RGB-decoding is performed using inter prediction or intra prediction for decoding a current image based on a previously decoded RGB image.

16. An RGB codec-based moving picture receiving apparatus comprising:
a receiver which receives a bit stream comprising an RGB codec-based transmission stream comprising an encoded RGB image and a transmission stream based on a codec different from the RGB codec;
an extracting unit which extracts the RGB codec-based transmission stream and the transmission stream based on the codec different from the RGB codec, from the bit stream; and
a decoding unit which determines whether the extracted transmission stream is an RGB codec-based transmission stream or a transmission stream based on the codec different from the RGB codec, and selectively performs RGB decoding or decoding corresponding to the codec different from the RGB codec, according to a result of the determination by the decoding unit,
wherein the decoding unit performs the RGB decoding using inter prediction or intra prediction for decoding a current image based on a previously decoded RGB image.

17. A computer-readable recording medium having embodied thereon a program for executing a moving picture transmitting method comprising:
performing RGB-encoding on an RGB image to generate an encoded RGB image;
receiving an audio bit stream; and
generating a transmission stream based on the encoded RGB image and the audio bit stream,
wherein the RGB-encoding is performed using intra prediction or inter prediction for RGB-encoding a current image based on a previous RGB image.

18. A computer-readable recording medium having embodied thereon a program for executing a moving picture transmitting method comprising:
determining whether an input image is an image having an RGB format;
selectively converting the input image into an RGB image according a result of the determining;
storing the input image or the converted image;
performing RGB-encoding on the stored image;
generating a transmission stream based on the RGB-encoded image; and
transmitting the transmission stream,
wherein the RGB encoding is performed using inter prediction or inter prediction for RGB-encoding a current image based on a previous RGB image.

19. A computer-readable recording medium having embodied thereon a program for executing a moving picture receiving method comprising:
receiving a transmission stream comprising an encoded RGB image and an audio bit stream;
extracting the encoded RGB image from a transmission stream; and
performing decoding on the encoded RGB image,
wherein the RGB decoding is performed using inter prediction or intra prediction for decoding a current image based on a previously decoded RGB image.

20. A computer-readable recording medium having embodied thereon a program for executing a moving picture receiving method comprising:
receiving a bit stream comprising an RGB codec-based transmission stream comprising an encoded RGB image and a transmission stream based on a codec different from the RGB codec;
extracting the RGB codec-based transmission stream and the transmission stream based on the codec different form the RGB codec, from the bit stream;
determining whether the extracted transmission stream is an RGB codec-based transmission stream or a transmission stream based on the codec different from the RGB codec; and
selectively performing RGB-decoding or decoding corresponding to the codec different from the RGB codec, according a result of the determining,
wherein the RGB-decoding is performed using inter prediction or intra prediction for decoding a current image based a previously decoded RGB image.
